(19) United States
(12) Patent Application Publication
(10) Pub. No.: US 2025/0026673 A1
(43) Pub. Date: Jan. 23, 2025

(54) Metal Surface Treatment Using Oxygenated Water

(71) Applicants: Shane N. Sauceman, Andersonville, TN (US); Michael W. York, Andersonville, TN (US)

(72) Inventors: Shane N. Sauceman, Andersonville, TN (US); Michael W. York, Andersonville, TN (US)

(21) Appl. No.: 18/772,599

(22) Filed: Jul. 15, 2024

Related U.S. Application Data
(60) Provisional application No. 63/527,572, filed on Jul. 18, 2023.

(51) Int. Cl. C02F 1/72; B67C 3/00; C02F 103/00

(52) U.S. Cl. CPC C02F 1/727; B67C 3/001; C02F 2103/002; C02F 2307/00

(57) ABSTRACT

A passivating system for stainless steel process equipment includes: an oxygenation system comprising a raw water inlet, an oxygen inlet, a porous membrane through which oxygen flows into the raw water to create oxygenated water and, an oxygenated water outlet; a fluid conduit providing the oxygenated water to a clean-in-place (CIP) system connected to the stainless steel process equipment; and, a control interface through which a user may circulate the oxygenated water through the piping for a selected time to improve the surface passivation after a cleaning cycle. The oxygenation system may be separate from the CIP system or they may be co-located on a skid or other common base. The oxygenated water preferably has a dissolved oxygen content of at least 20 mg/L.

### CROSS REFERENCE TO RELATED APPLICATION

This application claims the benefit of U.S. Prov. Pat. Appl. 63/527,572, entitled, “Stainless Steel Surface Treatment Using Oxygenated Water,” filed by the present inventors on Jul. 18, 2023, the entire disclosure of which is incorporated herein by reference.

### BACKGROUND OF THE INVENTION

### Field of the Invention

The invention pertains to apparatus and methods for metal surface treatments and more particularly to apparatus and methods for passivating stainless steels and refractory metals.

### Description of Related Art

Stainless steels achieve their corrosion resistance in part through the development of a passive layer, typically a thin, adherent film of predominantly chromium oxide. This film can sometimes become degraded by abrasion, for example, creating a need to re-passivate the surface before continued use.

In plants that process foods, beverages, and pharmaceuticals the quality of the passive layer on the metal facing the processed material is critically important. Such plants typically have dedicated “clean-in-place” (CIP) systems permanently installed as part of the process line. At a soda bottling plant, for instance, during changeover from one flavor to another, the operator initiates the cleaning cycle, which involves flushing all the pipes with a cleaning solution, rinsing, and in some cases taking steps to re-passivate the inside surfaces. Conventional passivation processes are typically carried out with hot acid solutions (mineral acids, nitric or citric acid) and often require as much as eight hours. These processes therefore incur large costs for machine downtime as well as chemicals and waste disposal. They further involve some risk to operators if the hot, corrosive solutions were to leak during the cleaning or disposal process.

When stainless steel components are welded, typically using the tungsten inert gas (TIG) process, the resulting weld is frequently discolored or tarnished. Systems such as the TIG Brush™ (Ensitech, Inc., Aurora, IL) use an electrolyte solution (predominantly phosphoric acid) and manually operated bristle brush electrode to clean and passivate the weld area. The process is fairly fast and easy to carry out, but the operator must then take considerable care to wash off the residual acid. Also, the brush process doesn't easily lend itself to large-area surface cleaning and passivation.

What is needed, therefore, is a process for re-passivation of stainless steel tanks, welds, and piping that is safe, environmentally benign, faster, and less costly. The process should be easily incorporated into, or compatible with, existing clean-in-place systems and other customer equipment.

### Objects and Advantages

Objects of the present invention include the following: providing an apparatus to create oxygen-oversaturated water for injection into stainless steel piping; providing an apparatus for injecting super-oxygenated water into a clean-in-place system; providing a clean-in-place system for food-contacting equipment that manages cleaning, rinsing, and passivation processes from a single control system; providing a method for passivating stainless steel that uses no toxic chemicals; providing anodized coatings on metals for decorative and other purposes using no toxic chemicals; and providing a method for cleaning and stabilizing stainless steel components at room temperature while creating no chemical waste stream. These and other objects and advantages of the invention will become apparent from consideration of the following specification, read in conjunction with the drawings.

### SUMMARY OF THE INVENTION

According to one aspect of the invention, a passivating system for stainless steel piping comprises:
an oxygenation system comprising:
   a raw water inlet;
   an oxygen inlet;
   a porous membrane through which oxygen flows into the raw water to create oxygenated water; and,
   an oxygenated water outlet;
a fluid conduit providing the oxygenated water to a clean-in-place system connected to the stainless steel piping; and,
a control interface through which a user may circulate the oxygenated water through the piping to improve the surface passivation after a cleaning cycle.

According to another aspect of the invention, a cleaning and passivating system for stainless steel piping comprises:
a clean-in-place system connected to the stainless steel piping and providing at least one cleaning cycle and at least one rinsing cycle;
an oxygenation system connected to the clean-in-place system, comprising:
   a raw water inlet;
   an oxygen inlet;
   a porous membrane through which oxygen flows into the raw water to create oxygenated water; and,
   an oxygenated water outlet; and,
a control interface through which a user may control the steps of the cleaning cycle, the rinsing cycle, and the circulation of the oxygenated water through the piping in a passivation cycle after a cleaning cycle.

According to another aspect of the invention, a method for passivating stainless steel piping comprises the steps of:
providing an oxygenation system comprising:
   a raw water inlet;
   an oxygen inlet;
   a porous membrane through which oxygen flows into the raw water to create oxygenated water; and,
   an oxygenated water outlet;
providing a fluid conduit to supply the oxygenated water to a clean-in-place system connected to the stainless steel piping;
providing a control interface through which a user may circulate the oxygenated water through the piping to improve the surface passivation after a cleaning cycle; and,
circulating the oxygenated water through the piping for a selected time at a selected temperature.

According to another aspect of the invention, a method for cleaning and passivating stainless steel piping comprises the steps of:
providing a clean-in-place system connected to the stainless steel piping, the clean-in-place system comprising:
   a pump and valve system to control injection, recirculation, and discharge of cleaning solutions; and,
   a control interface through which a user may control at least one cleaning cycle, at least one rinsing cycle, and at least one passivation cycle;
providing an oxygenation system integrated with the control interface and comprising:
   a raw water inlet;
   an oxygen inlet;
   a porous membrane through which oxygen flows into the raw water to create oxygenated water; and,
   an oxygenated water outlet to supply the oxygenated water to the clean-in-place system;
circulating a cleaning solution through the piping for a selected time at a selected temperature;
circulating rinse water through the piping for a selected time at a selected temperature; and,
circulating the oxygenated water through the piping for a selected time at a selected temperature to improve the passivation of the stainless steel.

According to another aspect of the invention, a passivating system for stainless steel components comprises:
an oxygenation system comprising:
   a raw water inlet;
   an oxygen inlet;
   a porous membrane through which oxygen flows into the raw water to create oxygenated water; and,
   an oxygenated water outlet;
a fluid conduit providing the oxygenated water to a reservoir into which selected stainless steel components may be placed; and,
a control interface through which a user may circulate the oxygenated water through the reservoir and control selected process parameters, including the oxygen oversaturation value, to improve the surface passivation of the stainless steel component.

According to another aspect of the invention, a passivating system for stainless steel surfaces comprises:
an oxygenation system comprising:
   a raw water inlet;
   an oxygen inlet;
   a porous membrane through which oxygen flows into the raw water to create oxygenated water; and,
   an oxygenated water outlet;
a fluid conduit providing the oxygenated water to a selected area of a stainless steel component; and,
a compliant applicator that is at least partially conductive, with which a user may apply an electrolytic current to the selected area wetted by the oxygenated water so that the selected area may be cleaned and passivated by the action of the electrolytic current and the oxygenated water.

According to another aspect of the invention, a passivating method for stainless steel process components comprises:
a) producing oxygenated water;
b) sealing the oxygenated water in a gas impermeable container;
c) shipping the container of oxygenated water to a point of use;
d) connecting the container of oxygenated water to an existing clean-in-place system connected to the stainless steel process components; and, e)1 circulating the oxygenated water through the stainless steel process components using the clean-in-place system.

According to another aspect of the invention, an anodizing system for refractory metal surfaces comprises:
a water bath comprising water with a dissolved oxygen level of at least 20 mg/L;
a refractory metal component to be anodized and a counter electrode, both contacting the water bath; and,
a DC power supply connected between the refractory metal electrode and the counter electrode to provide a selected anodizing potential.

According to another aspect of the invention, a method for anodizing refractory metal surfaces comprises the steps of:
a) fabricating a component from a selected refractory metal;
b) providing a counter electrode;
c) contacting the refractory metal component and the counter electrode with a water bath comprising a dissolved oxygen level of at least 20 mg/L;
d) applying a selected DC potential between the refractory metal component and the counter electrode for a selected time to produce an anodized film of a selected thickness on the refractory metal surface.

According to another aspect of the invention, a method for making tantalum capacitors comprises the steps of:
a) fabricating a first electrode comprising a porous tantalum body with a first tantalum wire lead extending from one end;
b) anodizing the first electrode at a selected potential in a water bath comprising a dissolved oxygen level of at least 20 mg/L to form a dielectric oxide layer of a selected thickness;
c) infiltrating the anodized porous tantalum body with a selected electrically conductive material; and,
d) inserting the infiltrated tantalum body in a second electrode comprising a tantalum can, thereby forming a capacitor.

### BRIEF DESCRIPTION OF THE DRAWINGS

The drawings accompanying and forming part of this specification are included to depict certain aspects of the invention. A clearer conception of the invention, and of the components and operation of systems provided with the invention, will become more readily apparent by referring to the exemplary, and therefore non-limiting embodiments illustrated in the drawing figures, wherein like numerals (if they occur in more than one view) designate the same elements. The features in the drawings are not necessarily drawn to scale.

FIG. 1A-B is a schematic diagram of one example of the present invention. FIG. 1A shows an outside view of an apparatus to produce oxygenated water. FIG. 1B shows the apparatus in cross section.

FIG. 2 is a schematic diagram of an oxygenation apparatus (membrane contactor) integrated with a clean-in-place (CIP) system.

FIG. 3 is a schematic diagram of a tool for cleaning and passivating a stainless steel surface, in which oxygenated water is pumped into an electrified brush.

### DETAILED DESCRIPTION OF THE INVENTION

The invention provides a method for passivating stainless steel pipe, tanks, and other fluid-handling systems using water that has been over-saturated with oxygen. The oxygen content is preferably about four times the equilibrium concentration of dissolved oxygen (DO) in water at ambient temperature (20 to 40 mg/L as-produced vs. ˜ 9 mg/L under normal equilibrium). Applicants have found that this oxygen-oversaturated water can effectively improve passivation, while eliminating toxic or noxious chemicals and their corresponding waste streams, and do so in a shorter time and at room temperature. The system may conveniently be integrated into existing clean-in-place systems that are familiar in the industry.

### Clean-In-Place Systems

Clean-in-place systems are in widespread use in industry, particularly in factories that make, process, and package foods, beverages, and pharmaceuticals. These might include canning and bottling lines for soft drinks, drinking water, sterile solutions, and food additives. Alcoholic beverage production may include specialized equipment such as mash tuns, fermentation tanks or vats, stills, pasteurizers, etc. In such facilities, the process tanks and piping are frequently fabricated from 300-series stainless steels. A typical CIP system is an efficient, fully automated process with multiple dedicated tanks, programmable logic controllers, highly accurate sensors, spray devices, heat exchangers, and automatic valves. [For background purposes, see “CIP (Clean-In-Place) Buying Guide”, Rev. 08/19, Central States Industrial, Springfield, MO, the entire contents of which are incorporated herein by reference.]

When the plant operator determines that the process piping must be passivated because the inner surfaces have become abraded or otherwise degraded, a passivation cycle is conducted involving either hot citric or hot nitric acid. The acid must then be thoroughly flushed from the system and the corrosive wastewater properly disposed of.

Oxygenation systems have been developed to provide large quantities of oxygenated water to industrial hydroponics systems. One such system has been developed by Applicants and is described in the following example.

### EXAMPLE

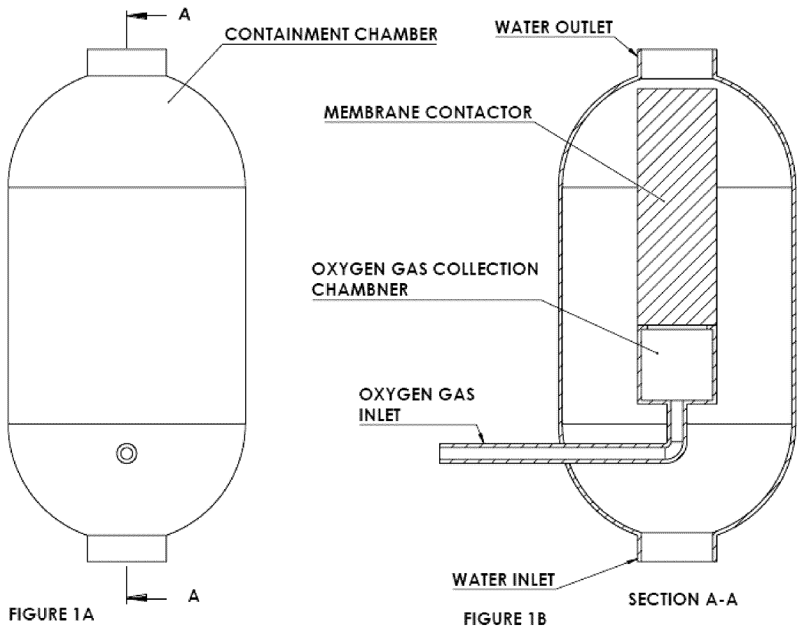

One suitable oxygenation apparatus is shown in FIGS. 1A-B. Referring to FIG. 1A, the apparatus comprises a sealed tank, preferably stainless steel, with an oxygen inlet, feed water inlet at one end, and oxygenated water outlet at the other end. Referring to FIG. 1B, oxygen enters via the inlet pipe and is maintained in the collection chamber at an elevated pressure (preferably 10 to 40 psi relative to ambient). This oxygen passes into a membrane contactor (BioTherm Solutions O2 TOOB Craft Dissolved Oxygen Infuser, 24 Inch; see: https://hydrobuilder.com/brands/biotherm-solutions.html) comprising a large number of hollow, microporous polymer fibers, from which the oxygen diffuses into the water. Oxygenated water flows out through the water outlet.

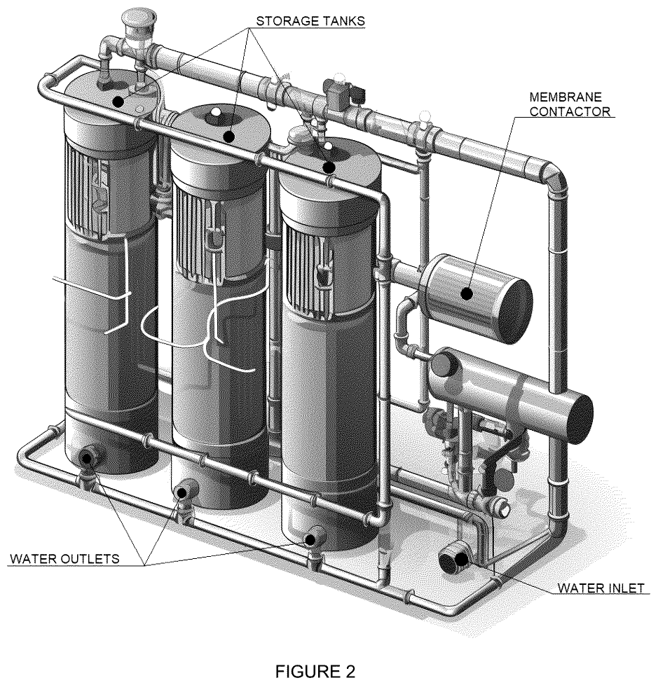

Although the tank shown in FIG. 1 is vertically oriented, it will be appreciated that it may be positioned in any desired orientation. For example, in FIG. 2 it is shown in a horizontal orientation for convenient incorporation into a CIP system. Regardless of how the tank is oriented, it is preferable that the fibers are oriented vertically for proper functioning of the oxygenation process.

### EXAMPLE

The oxygen content produced by the oxygenation apparatus described in the foregoing example is preferably about four times the equilibrium concentration of dissolved oxygen (DO) in water at ambient temperature (20 to 40 mg/L as-produced vs. ˜ 9 mg/L under normal equilibrium). Applicants have found that such oxygenated water left in open barrel conditions at room temperature indoors lost 40% of saturation over a 24 h period. The actual rate of loss will vary somewhat depending on temperature, humidity, and barometric pressure. It will be appreciated that the oxygenated water may be stored in a closed and/or pressurized container to reduce or eliminate oxygen losses.

Several tests were conducted to determine if highly oxygenated water can be used to passivate stainless steel, as an alternative to acid treatments.

### EXAMPLE

Stainless steel test coupons (AISI 304, AISI 316) were prepared by lightly abrading the surfaces to remove the existing passivation layer. Samples were then passivated by various methods:
1. Treatment in hot nitric acid solution (ASTM A 967-05, Nitric 5: Other combinations of temperature, time, and acid with or without accelerants, inhibitors or proprietary solutions capable of producing parts that pass the specified test requirements);
2. Treatment using a manual applicator following the manufacturer's instructions (TIG Brush™ Model TBE-550 manufactured by Ensitech, 340 Marshall Ave, Bldg. 104, Aurora, IL 60506) using the associated proprietary phosphoric acid blend TB-25; and,
4. Treatment by simple immersion in oxygenated water at 20, 30, and 40 mg/L DO produced in accordance with the inventive method, along with a control immersed in untreated tap water. The DO was measured using an OxyGuard Handy Polaris TGP (OxyGuard International A/S, Farum, Denmark).

### EXAMPLE

The aforedescribed test coupons were then evaluated by several methods:
1. Direct examination by scanning electron microscopy/microanalysis (SEM) per ASTM B748-90 (21) and ASTM E1508-12a (19);
2. Copper sulfate passivation test per ASTM A380-90 (21); and,
3. Spot testing using a handheld probe (SURFOX™ Model 54T012 passivation tester).

Each specimen was tested first with the Surfox 54T012 passivation tester both before removing the oxide layer and after. All samples were found to be passive as received from the mill, and were confirmed to have no visible oxide layer prior to treatment. The first set of samples was exposed to high concentrations of dissolved oxygen; the specimens were taken from the oxygenated water tank, dried, cleaned, tested, and returned to the water every hour until a positive passivation test was achieved. Both specimens of Grade 304 and 316 achieved positive passivation test after 4 hours of exposure. The second set of samples was sent to a third party treatment vendor to be passivated using conventional acid passivation methods (ASTM A967, Nitric 5). For test 1 and test 2 SEM analysis was unable to measure thickness of oxide on the surface, which in a typical stainless steel is below the resolution limit of the SEM. Both sets of samples showed negative for free iron in the copper sulfate surface test. The control group (exposure to ambient air) was tested every hour at room temperature and moderate humidity; those specimens failed to show any passivation after 24 hours.

### EXAMPLE

The inventive system was tested in a commercial bottling plant on a line configured to produce canned drinks. The bottling line had an existing clean-in-place system.

Equipment: The test was performed on a 350-gallon 316 grade stainless steel sanitary tank fitted internally with a conventional spray ball. The inventive system includes the previously described oxygenation unit and an additional enclosed 50-gallon 304 grade stainless steel sanitary tank. Dissolved oxygen (DO) content and temperature was monitored with an OxyGuard Handy Polaris TGP with a measurement range DO: 0-60.0 ppm (mg/l), 0-600% saturation and 0-60% volume, temperature: −5 to 45 ° C. and accuracy DO: better than +/−1% of value +/−1 digit, temperature: +/− 0.2° C. Passive readings were performed with a Walter 54T012 Surfox open circuit potential tester. Calibration was performed on site before each measurement with supplied validation pieces (+val: +0.56), (−val:−0.57).

Procedure: To perform the test, the 50-gallon reserve tank was filled with on-site tap water. The tap water was circulated through the oxygenation system for approximately 30 minutes to raise the dissolved oxygen content. While the oxygenator was running, the 350-gallon tank was drained and passive measurements were taken on the tank as well as a control sample. The control sample consisted of a test coupon with its passive layer completely removed prior to the test. It was exposed by immersion in the 50 gallon tank while the test was running.

When the DO had reached a sufficient level, confirmed with OxyGuard readings, the oxygenated water was transferred from the reserve tank to the 350-gallon tank to be circulated through the existing clean in place (CIP) loop. Water was circulated for approximately 1 hour 10 minutes in closed-loop mode, (i.e., no additional oxygenation was done during recirculation) and then drained back into the reserve tank. Test sites were wiped dry and passive readings were taken again for the tank and control specimen, Table 1.

TABLE 1
Passivation results using recirculating oxygenated
water in a CIP system at 62° F.

| Time, min | 0 | 70 |
|---|---|---|
| Location 1 in tank | +0.22 | +0.58 |
| Location 2 in tank | +0.15 | +0.48 |
| Control specimen | −0.20 | +0.35 |
| Oxygen saturation | 220% | 175% |

One can see from Table 1 that passivation was significantly improved at both measured locations in the process tank as well as in the initially un-passivated control sample. As no additional oxgenation was done on the water during the recirculation mode, the DO level decreased during the run, from 220% to 175% representing the consumption of oxygen to form the passive chromium oxide layer. One cannot rule out the possibility that some of the observed decrease might also be attributed to sparging of the oxygen from the water during the spraying process.

### Other Passivation Applications.

In addition to CIP systems, there are other situations where it is desirable to passivate a particular component that isn't part of an installed system. This includes passivating a single pipe section, valve, or fitting that is being installed or replaced into a larger system, as in clean-out-of-place (COP) settings.

Passivation in a bath usually involves immersion in a mild nitric acid solution for 24 to 48 hours. Passivation is a chemical treatment applied to stainless steel parts to provide resistance to oxidation, rusting and mild chemical attack. The passivation process removes free iron (ferric material) from the surface of the parts that can be created during finishing operations such as milling, buffing, lapping, cutting, etc. These contaminants create potential sites for corrosion that result in premature deterioration of the component. The acids used for passivation dissolve much of the alloyed iron on an atomic level right at the surface leaving a chromium and nickel-rich surface. It then creates the formation of a thin oxide film that protects the stainless steel from corrosion.

The invention may be integrated into a bath system such as that in the Small 386P Benchtop Ultrasonic Stainless Steel Part Passivation Equipment https://www.besttechnologyinc.com/passivation-systems/ultrasonic-stainless-steel-part- passivation-equipment/. In order to test this application, ultrasonic treatment in a small ultrasonic tank was conducted as described in the following example.

### EXAMPLE

An ultrasonic bath was filled with high-DO and low-DO water to determine the effect of high DO levels and simultaneous ultrasonic treatment.

### Equipment and setup

Preparation of high DO water was done as previously described. The control was untreated tap water.

TABLE 2
Ultrasonic treatment results.

| Alloy | DO, mg/L^{a} | Treatment time, h | Passive Y/N^{b} |
|---|---|---|---|
| 304 | 38 | 1 | N |
| 316 | 38 | 2 | Y |
| 304 | 38 | 4 | Y |
| 304 | tap water | 1 | N |
| 316 | tap water | 2 | N |
| 304 | tap water | 4 | N |

^{a}Measured with OxyGuard Handy Polaris TGP
^{b}Measured with SURFOX ™ Model 54T012 passivation tester

### Integration of Oxygenated Water and Electrolytic Treatment.

As previously discussed, the TIG Brush™ system is designed to remove surface tarnish or discoloration from a weld bead on stainless steel. A solution is applied to the weld bead and then an electrolytic brush is passed along the weld to facilitate the chemical reaction between the solution and the surface oxides on the weld.

### EXAMPLE

An electrolytic metal surface treatment system may include a suitable power supply, a conductive brush, and an oxygenated water supply. The operator would set the power supply at a desired level, dip the conductive brush into a reservoir of oxygenated water, and brush it on the surface to be passivated.

The concept was tested using a commercial power supply and brush, with various solutions as shown in the following table. The weld was made on Type 316 stainless steel.

TABLE 3
Electrolytic weld cleaning process results.

| Power setting^{a} | Solution | Results^{b} |
|---|---|---|
| Cleaning | TB-25^{c} | 5 clean and shiny |
| Cleaning | High DO water | 4 slight water |
| | | scale remained |
| Cleaning | Hydrogen peroxide 3% solution | 3 moderate scale, |
| | | color remained |
| Cleaning | Tap water | 1 most of color |
| | | and scale |
| | | remained |

^{a}Power selector setting on Ensitech TIG Brush ™ Model TBE-550 power supply; actual voltage and current are not specified
^{b}Qualitative cleanliness based on visual examination, 5 = best
^{c}Ensitech proprietary phosphoric acid mixture

### EXAMPLE

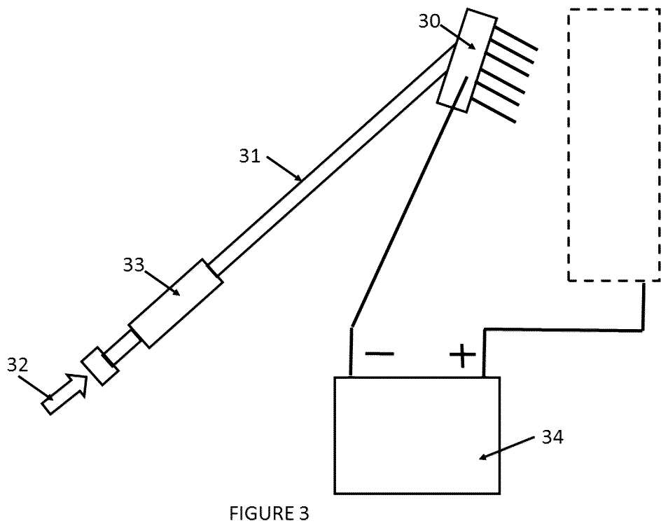

As shown schematically in FIG. 3, for cleaning and passivating larger surfaces, a conductive brush 30 may be configured to include a pipe or hose supplying a continuous or on-demand supply of oxygenated water 32. The inlet pipe may be configured as a rigid pole 31 with a hand grip 33, as shown, for convenience for reaching large areas of a structure (dashed lines) to be treated. Alternatively, a short hand grip, not shown, may be attached directly to the brush 30 for close-in treatment of a more localized surface. A DC power supply 34 is provided, with the negative electrode connected to brush 30 and the positive electrode connected to the workpiece. The operator would adjust the power supply, turn on the flow of oxygenated water, and brush the surface to be treated. This method might be suitable for cleaning rust stains and the like from a large stainless steel component that has been exposed to the weather, for example.

It will be appreciated that ancillary controls may be provided, as are well known in the art. For example, the hand grip may be provided with a trigger to control the flow of oxygenated water; such trigger may also control the power supply so that the brush is only electrified when water is actually flowing, in order to reduce wear on the conductive brush. Alternatively, the control may be arranged as a foot switch as is known in the art.

The invention may further be incorporated in other electrolytic processes, such as anodizing. Some examples include developing decorative oxidation films on niobium, titanium, or tantalum for jewelry or other personal items; developing the oxide dielectric film on porous tantalum compacts in the production of tantalum capacitors; and many other applications. In these situations it is contemplated that the process will include a power supply and counter electrode, and a bath comprising oxygenated water, alone or in combination with other additives such as mild acids or alkalis, surfactants, etc., for further controlling the microstructure and other characteristics of the anodic film to be developed.

### Decorative Anodized Coatings and Films.

The invention was used to create anodized films of selected colors on metal sheets as described in the following example.

### EXAMPLE

Samples of niobium, and tantalum were obtained as sheet stock. Oxygenated water with around 30-40 mg/L DO was prepared in accordance with the inventive method. A DC power supply was used with output controlled to selected levels up to around 30 VDC. Applicants observed that anodic films could be formed that had different colors, either by changing the voltage or exposure time, or both.

Tantalum: Coupons were exposed to tap water (pH 8.0, 24° C., and DO 7.17 mg/L) and to oxygenated water (pH 8.2, 23° C., and DO 35.6 mg/L). Each exposure was continued for 90 seconds, Table 4.

TABLE 4
Anodization colors formed on tantalum sheet.

| Voltage | Tap Water | Oxygenated water |
|---|---|---|
| 10 | no color | gray |
| 20 | pale tan | bronze |
| 27.2 | purplish blue | dark blue |

Niobium: A preliminary test was done using oxygenated water and niobium sheet. Positive results were obtained; at 27 V a violet film was developed, and at 36 V a dark blue film was formed.

It will be appreciated that the inventive process may be further modified to create more artistic coatings for other esthetic uses. The article being anodized may be slowly withdrawn from the bath, so that the coating thickness (color) gradually varies along the length. Instead of a bath, an electrified brush may be used to “brush on” localized swaths or spots of various colors. The surface may be masked using any conventional approach, such as masking with paper or tape, or painting on enamel in some selected pattern that is later removed after anodizing.

Based on the foregoing results, Applicant recognized that the process could be applied to the development of anodized dielectric films for the production of tantalum capacitors. In the conventional process, anodization is typically conducted in an acid bath. The anodizing voltage is set to achieve a certain thickness of oxide film, which is typically evaluated by visual inspection and comparison of the film color to that of reference samples anodized to the target thickness.

### CIP Systems Versus New Construction.

For a newly built system, for example, a stainless steel tank, the process steps will typically include:
a) fabricate the component by any combination of forming, cutting, machining, welding, etc., as are known in the art of metal fabrication;
b) clean as needed to remove surface contamination, weld spatter, cutting lubricants, etc.;
c) expose all fluid contacting surfaces to water having a dissolved oxygen content of 20 to 40 mg/L for a sufficient time to passivate the surface.

For a clean-in-place system, the process steps will typically include:
a) isolate the component to be cleaned from the existing process line;
b) flush out remaining product;
c) introduce cleaning solution and circulate/hold for a prescribed time;
d) flush cleaning solution;
e) introduce water having a dissolved oxygen content of 20 to 40 mg/L and circulate/hold for a sufficient time to passivate the surface;
f) drain and reconnect to process line.

It will be appreciated that the invention is not only suitable for use in stainless steel process piping and tanks, but may equally well be used for stainless steel tanks and piping mounted on trailers, rail cars, and other transport systems, firefighting vehicles, etc. Furthermore, the invention may be applied to specific cosmetic issues and passivation needs that might arise in stainless steel sheet products used for such things as household appliances, vehicle bodies and trim, etc.

### Providing Oxygenated Water to an Existing CIP System as a Service.

It will be appreciated that many small-scale operators, such as specialty bottling plants, microbreweries, etc., may desire the benefits of the inventive process, but even if they have a small-scale CIP system at their facility they might not have sufficient floor space available on their production line to accommodate permanently installing the inventive oxygenation components at their site. The following example describes a solution to this particular need.

### EXAMPLE

The steps of a method for providing oxygenated-water passivation services to customers would include:
a) producing oxygenated water off-site;
b) sealing the oxygenated water in a gas impermeable container;
c) shipping the container of oxygenated water to a point of use at a customer;
d) connecting the container of oxygenated water to an on-site clean-in-place system connected to the stainless steel process components; and,
e) circulating the oxygenated water through the stainless steel process components using the existing clean-in-place system.

It will be appreciated that incidental hardware components may be provided to facilitate connecting the water container to the customer's CIP system. Such custom fittings may be added permanently or semi-permanently to the customer's CIP system. Alternatively, connecting hardware might be carried to the site along with the bottled water as part of the servicing operation. Lastly, each bottle may be fitted with standardized hardware, such as a tri clamp ferrule, for compatibility with existing plant equipment. Hardware on the bottle may be further adapted to provide a convenient port for inserting a dissolved oxygen probe, as described in the following example.

### On-Site Verification of Oxygen Content.

### EXAMPLE

Applicants have conducted a series of tests to understand broadly the relative shelf life of the oxygenated water and have generally found it to be surprisingly good, even in open containers. Nevertheless, Applicants anticipate that, depending on the stringency of the process requirements (e.g., food products and beverages versus pharmaceuticals) it might be desirable to measure and document the actual level of oxygen in the bottled water immediately prior to injection into the process equipment being treated. Such on-site verification might also be desirable at customer plants located at high elevations.

In this situation, the inventive method includes the following steps:
a) producing oxygenated water off-site;
b) sealing the oxygenated water in a gas impermeable container;
c) shipping the container of oxygenated water to a point of use at a customer;
d) unsealing the oxygenated water container;
e) measuring the instant dissolved oxygen (DO) level in the water container;
f) connecting the container of oxygenated water to an on-site clean-in-place system connected to the stainless steel process components; and,
g) circulating the oxygenated water through the stainless steel process components for a selected time using the clean-in-place system.

It will be appreciated that step (e) might include any or all of the following steps:
e′) documenting the actual value of dissolved oxygen in the container;
e″) rejecting a water container if the dissolved oxygen level is below specifications; and,
e′″) connecting the container to the CIP system if the dissolved oxygen level is within specifications.

The DO may be measured by any convenient means, e.g., using an OxyGuard Handy Polaris TGP (OxyGuard International A/S, Farum, Denmark). Those skilled in the art will appreciate that many DO measuring systems are available in the industry, and are typically small, handheld devices well suited to use at the point of delivery of the inventive bottled oxygenated water.

### Summary of Various Aspects of the Invention.

A passivating system for stainless steel piping may comprise:
an oxygenation system comprising:
   a raw water inlet;
   an oxygen inlet;
   a porous membrane through which oxygen flows into the raw water to create oxygenated water; and,
   an oxygenated water outlet;
a fluid conduit providing the oxygenated water to a clean-in-place system connected to the stainless steel piping; and,
a control interface through which a user may circulate the oxygenated water through the piping to improve the surface passivation after a cleaning cycle.

The raw water inlet may be connected to a source of tap water, mill water, or other suitable source of process water, depending on the particular application. Such water may conform to various applicable standards as are well known in the art.

The oxygen inlet may be connected to an oxygen source, which may, for example, be a tank of compressed oxygen, a supply of liquid oxygen, or an oxygen generator as are well known in the art.

The porous membrane may comprise a plurality of hollow microporous polymer fibers. The fibers may further comprise a hydrophobic coating.

The oxygenated water may have an oxygen concentration ranging from 20 to 40 mg/L or about 2 to 4 times the equilibrium oxygen saturation level in water at 20° C.

The control interface may control pumps, valves, sources of heating or cooling, and may monitor and/or control process variables such as time, temperature, pH, and fluid flow rates. The control system may include a graphical user interface or other user experience features as are known in the art. Selected process menus may be automated or they may be under specific user controls.

According to another aspect of the invention, a cleaning and passivating system for stainless steel piping may comprise:
a clean-in-place system connected to the stainless steel piping and providing at least one cleaning cycle and at least one rinsing cycle;
an oxygenation system connected to the clean-in-place system, comprising:
   a raw water inlet;
   an oxygen inlet;
   a porous membrane through which oxygen flows into the raw water to create oxygenated water; and,
   an oxygenated water outlet; and,
a control interface through which a user may control the steps of the cleaning cycle, the rinsing cycle, and the circulation of the oxygenated water through the piping in a passivation cycle after a cleaning cycle.

The clean-in-place system may be pallet mounted and movable from place to place within a facility, or it may be permanently installed as part of a process line.

According to another aspect of the invention, a method for passivating stainless steel piping may comprise the steps of:
providing an oxygenation system comprising:
   a raw water inlet;
   an oxygen inlet;
   a porous membrane through which oxygen flows into the raw water to create oxygenated water; and,
   an oxygenated water outlet;
providing a fluid conduit to supply the oxygenated water to a clean-in-place system connected to the stainless steel piping;
providing a control interface through which a user may circulate the oxygenated water through the piping to improve the surface passivation after a cleaning cycle; and,
circulating the oxygenated water through the piping for a selected time at a selected temperature.

According to another aspect of the invention, a method for cleaning and passivating stainless steel piping may comprise the steps of:
providing a clean-in-place system connected to the stainless steel piping, the clean-in-place system comprising:
   a pump and valve system to control injection, recirculation, and discharge of cleaning solutions; and,
   a control interface through which a user may control at least one cleaning cycle, at least one rinsing cycle, and at least one passivation cycle;
providing an oxygenation system integrated with the control interface and comprising:
   a raw water inlet;
   an oxygen inlet;
   a porous membrane through which oxygen flows into the raw water to create oxygenated water; and,
   an oxygenated water outlet to supply the oxygenated water to the clean-in-place system;
circulating a cleaning solution through the piping for a selected time at a selected temperature;
circulating rinse water through the piping for a selected time at a selected temperature; and,
circulating the oxygenated water through the piping for a selected time at a selected temperature to improve the passivation of the stainless steel.

According to another aspect of the invention, a system for anodizing a selected metal component comprises:
a DC power supply delivering power to an anode and a cathode, wherein said anode comprises a metal component to be treated and said cathode comprises a counter electrode;
an aqueous bath into which said metal component and said counter electrode are immersed, wherein said aqueous bath comprises water having a dissolved oxygen content from about 20 to 40 mg/L.

The metal component may comprise aluminum, titanium, zinc, magnesium, niobium, zirconium, hafnium, or tantalum and their alloys.

The aqueous bath may further comprise mild acids, mild alkalis, organic salts such as citrates, dyes, and surfactants.

According to another aspect of the invention, an anodizing system for refractory metal surfaces may comprise:
a water bath comprising water with a dissolved oxygen level of at least 20 mg/L;
a refractory metal component to be anodized and a counter electrode, both contacting the water bath; and,
a DC power supply connected between the refractory metal electrode and the counter electrode to provide a selected anodizing potential.

The refractory metal may comprise niobium, tantalum, titanium or alloys thereof, and may comprise any selected form factor such as a wrought component or casting, a porous sintered compact, a rolled, stamped, or formed sheet, extrusion, or drawn wire. The refractory metal may comprise a continuous sheet, strip, wire or web, and may pass through one or more anodizing baths while supported by rollers or other familiar hardware. In such continuous treatment, an oxygenation unit may be installed on the line to continuously replenish the DO level in the bath during operation. The refractory metal may comprise a surface coating on a selected substrate; such substrate may preferably comprise a ferrous alloy and more preferably comprise stainless steel.

According to another aspect of the invention, a method for anodizing refractory metal surfaces may comprise the steps of:
a) fabricating a component from a selected refractory metal;
b) providing a counter electrode;
c) contacting the refractory metal component and the counter electrode with a water bath comprising a dissolved oxygen level of at least 20 mg/L;
d) applying a selected DC potential between the refractory metal component and the counter electrode for a selected time to produce an anodized film of a selected thickness on the refractory metal surface.

According to another aspect of the invention, a method for making tantalum capacitors may comprise the steps of:
a) fabricating a first electrode comprising a porous tantalum body with a first tantalum wire lead extending from one end;
b) anodizing the first electrode at a selected potential in a water bath comprising a dissolved oxygen level of at least 20 mg/L to form a dielectric oxide layer of a selected thickness;
c) infiltrating the anodized porous tantalum body with a selected electrically conductive material; and,
d) inserting the infiltrated tantalum body in a second electrode comprising a tantalum can, thereby forming a capacitor.

The electrically conductive material may comprise manganese dioxide, preferably formed via pyrolysis of manganese nitrate.

1. A passivating system for stainless steel process equipment comprising:
an oxygenation system comprising:
a raw water inlet;
an oxygen inlet;
a porous membrane through which oxygen flows into the raw water to create oxygenated water; and,
an oxygenated water outlet;
a fluid conduit providing the oxygenated water to a clean-in-place system connected to the stainless steel process equipment; and,
a control interface through which a user may circulate the oxygenated water through the piping for a selected time to improve the surface passivation after a cleaning cycle.

2. The passivating system of claim 1 wherein the oxygenated water is characterized by a dissolved oxygen content of at least 20 mg/L.

3. The passivating system of claim 1 wherein the oxygenated water is characterized by a dissolved oxygen content from about 200 to 400% of the equilibrium oxygen saturation value in water at 20° C.

4. The passivating system of claim 1 wherein the clean-in-place system is installed on a stationary skid.

5. The passivating system of claim 4 wherein the oxygenation system is installed with the clean-in-place system on the stationary skid.

6. The passivating system of claim 1 wherein the process equipment to be treated is located at a first site and the oxygenation system is operated at a second site remote from the first site, and wherein:
the oxygenated water is transported from the generation site to the use site in a closed tank; and,
the closed tank comprises a fluid coupling to connect the tank to the clean-in-place system.

7. The passivating system of claim 1 wherein the process equipment is used to process a material selected from the group consisting of: foodstuffs, beverages, pharmaceuticals, drinking water, food additives, and sterile solutions.

8. The passivating system of claim 1 wherein the process equipment comprises a canning line.

9. The passivating system of claim 1 wherein the process equipment comprises a bottling line.

10. The passivating system of claim 1 wherein the process equipment comprises at least one component for the production of alcoholic beverages selected from the group consisting of: vats, mash tuns, fermentation tanks, pasteurizing equipment, and stills.

11. The passivating system of claim 1 wherein the stainless steel comprises an alloy selected from the group consisting of 300-series stainless steels.
